(19) United States
(12) Patent Application Publication
(10) Pub. No.: US 2007/0191981 A1
(43) Pub. Date: Aug. 16, 2007

(54) System and method for processing sheet metal

(75) Inventors: Kuo-Jung Huang, Tu-Cheng (TW); Feng-Ping Tsai, Tu-Cheng (TW); Ze-Jun Dai, Shen-Zhen (CN); Yun-Feng Zhang, Shen-Zhen (CN); Jin-Song Li, Shen-Zhen (CN); Chun-Lin Zhou, Shen-Zhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,862

(22) Filed: Oct. 16, 2006

(30) Foreign Application Priority Data
Dec. 16, 2005 (TW) 94144785

(51) Int. Cl. G06F 19/00

(52) U.S. Cl. 700/166; 700/182

(57) ABSTRACT

A sheet metal processing method for generating punching codes and laser codes includes: reading an engineering drawing, and setting punching parameters; laying out workpieces, and generating punching multi-layout data; selecting and laying out corresponding punching tools for the workpieces and tooling-holes, and generating punching tool layout data; generating the punching codes according to the punching parameters, the punching tool layout data, and the punching multi-layout data, and saving the punching codes in a saving sub-system; retrieving the punching parameters, the punching tool layout data, and the punching multi-layout data of the punching codes, and automatically setting laser parameters and laser multi-layout data; and generating the laser codes according to the laser parameters and the laser multi-layout data. A sheet metal processing system for generating the punching codes and the laser codes is also provided.

### FIELD OF THE INVENTION

The present invention relates to systems and methods for processing sheet metal, and specifically to a system and method for combining processes in sheet metal processing.

### DESCRIPTION OF RELATED ART

With the ongoing globalization of commerce, market competition between modern international corporations has become more and more intense. All such corporations engaged in machining have to try their best to improve their competitiveness. Improving production efficiency is a never-ending challenge. Improvements in sheet metal machining and reduction to commodity prices have increase many corporations' efficiency competitiveness.

The use of computers in automatic sheet metal machining has become popular, and has effectively improved the speed and quality of sheet metal machining. Sheet metal machining usually includes laser cutting, numerical control turret punching, shearing and so on. Current sheet metal machining usually involves computer aided design (CAD) to define workpieces according to engineering drawings, computer aided manufacturing (CAM) to select optimum machining paths, generation of computer numerical control (CNC) codes, and transmission of the CNC codes to factories.

In the current sheet metal machining process, sheet metal is punched into workpieces on a punching machine at first, and then sheet metal must be prepared to be cut into pieces on a laser machine. The separation of the punching process and the laser cutting process in sheet metal machining is not convenient and wastes time. Thus, the conventional sheet metal machining process from the punching to the laser cutting is inefficient.

Therefore, a heretofore unaddressed need exists in the industry to overcome the aforementioned deficiencies and inadequacies.

### SUMMARY OF THE INVENTION

An exemplary embodiment of the present invention provides a sheet metal processing system for generating punching codes and laser codes. The sheet metal processing system includes a punching sub-system, a saving sub-system, and a laser sub-system. The punching sub-system includes a punching parameter setting module, a punching multi-layout module, a punching tool layout module, and a punching code generating module. The punching parameter setting module is used for reading an engineering drawing, receiving a first input message and a second input message, and setting punching parameters. The punching multi-layout module is used for laying out workpieces according to the punching parameters and generating punching multi-layout data. The punching tool layout module is used for selecting and laying out corresponding punching tools according to the punching parameters for the workpieces and tooling-holes and generating punching tool layout data. The punching code generating module is used for generating the punching codes according to the punching parameters, the punching tool layout data, and the punching multi-layout data. The saving sub-system is used for saving the punching codes generated by the punching sub-system. The laser sub-system is used for retrieving the punching parameters, the punching tool layout data, and the punching multi-layout data of the punching codes from the saving sub-system, setting laser parameters and laser multi-layout data, and generating the laser codes according to the laser parameters and the laser multi-layout data.

Another exemplary embodiment of the present invention provides a sheet metal processing method for generating punching codes and laser codes. The sheet metal processing method includes: reading an engineering drawing, and setting punching parameters; laying out workpieces and generating punching multi-layout data; selecting and laying out corresponding punching tools for the workpieces and tooling-holes, and generating punching tool layout data; generating punching codes according to the punching parameters, the punching tool layout data, and the punching multi-layout data, and saving the punching codes in a saving sub-system; retrieving the punching parameters, the punching tool layout data, and the punching multi-layout data of the punching codes from the saving sub-system, and automatically setting laser parameters and laser multi-layout data; and generating the laser codes according to the laser parameters and the laser multi-layout data.

Other advantages and novel features will become more apparent from the following detailed description when taken in conjunction with the accompanying drawings, in which:

### BRIEF DESCRIPTION OF THE DRAWINGS

FIG. 1 is a block diagram of a sheet metal processing system of an exemplary embodiment of the present invention;

FIG. 2 is a block diagram of a sheet metal processing system of another exemplary embodiment of the present invention;

FIG. 3 is a flowchart of a sheet metal processing method of a further exemplary embodiment of the present invention;

FIG. 4 is a flowchart of a punching method of the sheet metal processing method of an exemplary embodiment of the present invention; and

FIG. 5 is a flowchart of a laser cutting method of the sheet metal processing method of an exemplary embodiment of the present invention.

### DETAILED DESCRIPTION OF THE INVENTION

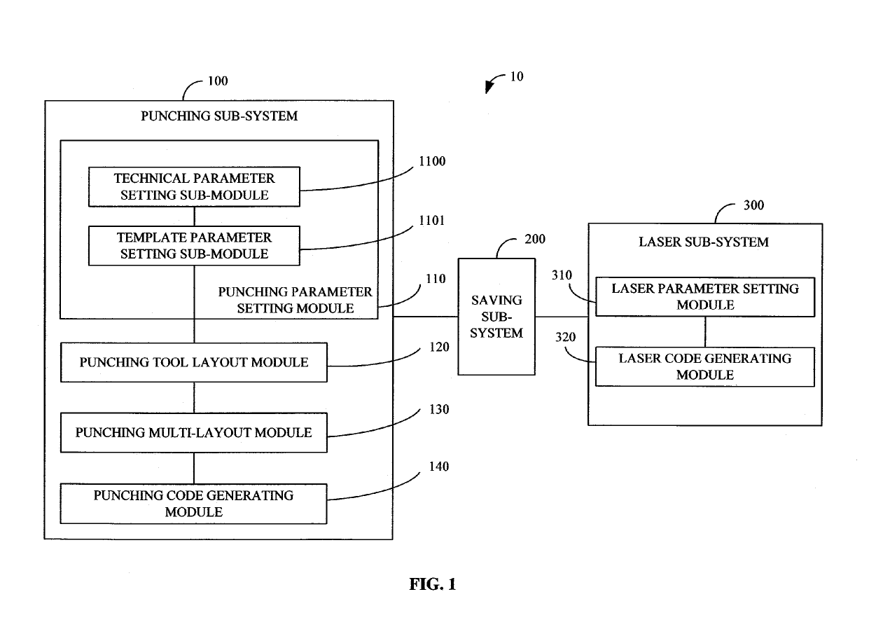

FIG. 1 is a block diagram of a sheet metal processing system 10 of an exemplary embodiment of the present invention. The sheet metal processing includes at least two machining processes including a punching process and a laser process. The sheet metal processing system 10 includes a punching sub-system 100, a saving sub-system 200, and a laser sub-system 300. The punching sub-system 100 is used for providing a punching standard for punching sheet metal into workpieces. The laser sub-system 300 is for providing a laser standard for cutting other parts of the sheet metal into workpieces and cutting the punched workpieces.

The punching sub-system 100 includes a punching parameter setting module 110, a punching tool layout module 120, a punching multi-layout module 130, and a punching code generating module 140.

The punching parameter setting module 110 is used for reading an engineering drawing, receiving a first input message and a second input message, and setting punching parameters according to the first input message and the second input message. In the exemplary embodiment, the first input message includes machining materials and machining modes of the sheet metal, and the second input message includes template types of the sheet metal processing. The punching parameter setting module 110 includes a technical parameter setting sub-module 1100 and a template parameter setting sub-module 1101. In the exemplary embodiment, the punching parameters include technical parameters and template parameters.

The technical parameter setting sub-module 1100 is used for reading the engineering drawing, receiving the first input message, and automatically setting the technical parameters according to the first input message. In the exemplary embodiment, the technical parameters include length, width, thickness, and machining characteristic of the sheet metal. In the exemplary embodiment, after receiving the machining materials and the machining modes of the sheet metal, the technical parameter setting sub-module 1100 automatically sets the technical parameters corresponding to the machining materials and the machining modes. In another exemplary embodiment, operators can also manually modify the technical parameters via the technical parameter setting sub-module 1100.

The template parameter setting sub-module 1101 is used for receiving the second input message and automatically setting the template parameters according to the second input message. In the exemplary embodiment, the template parameters include template types, template sizes, locations of tooling-holes, spacing between the tooling-holes, and quantities of the tooling-holes. In the exemplary embodiment, after receiving the template types of the sheet metal processing, the template parameter setting sub-module 1101 can automatically set the template parameters corresponding to the template types.

The punching tool layout module 120 is used for automatically selecting corresponding punching tools for the workpieces and the tooling-holes according to the punching parameters, laying out machining sequences of the selected punching tools, and automatically generating punching tool layout data. In the exemplary embodiment, the punching tool layout data include the selected punching tools for punching the workpieces and the tooling-holes and the machining sequences of the selected punching tools.

The punching multi-layout module 130 is used for laying out the workpieces according to the punching parameters, and automatically generating punching multi-layout data. In the exemplary embodiment, the punching multi-layout data include quantities of the workpieces, spacing between the workpieces, and surplus spaces after punching all the workpieces.

The punching tools for the tooling-holes must be laid out after laying out the workpieces, whereas the punching tools for the workpieces can be laid out either before or after laying out the workpieces.

The punching code generating module 140 is used for automatically generating punching codes according to the punching parameters, the punching tool layout data, and the punching multi-layout data. In the exemplary embodiment, the punching codes include the punching parameters, the punching tool layout data, and the punching multi-layout data. The workpieces can be machined according to the punching codes.

The saving sub-system 200 is used for saving the punching codes generated by the punching sub-system 100. In the exemplary embodiment, the saving sub-system 200 may be a database.

The laser sub-system 300 is used for retrieving the punching parameters, the punching tool layout data, and the punching multi-layout data of the punching codes from the saving sub-system 200, and automatically setting laser parameters and laser multi-layout data according to the punching parameters, the punching tool layout data, and the punching multi-layout data. Then the laser sub-system 300 generates laser codes according to the laser parameters and the laser multi-layout data. The laser sub-system 300 includes a laser parameter setting module 310 and a laser code generating module 320.

The laser parameter setting module 310 is used for retrieving the punching parameters of the punching codes from the saving sub-system 200 to automatically set the laser parameters, and retrieving the punching tool layout data and the punching multi-layout data of the punching codes from the saving sub-system 200 to automatically set the laser multi-layout data. The laser code generating module 320 is used for automatically generating the laser codes according to the laser parameters and the laser multi-layout data. The workpieces are machined according to the laser codes.

In the exemplary embodiment, the laser parameters include laser technical parameters and laser template parameters. The laser technical parameters include length, width, thickness, and machining characteristic of the sheet metal. The laser template parameters include template types, template sizes, locations of tooling-holes, spacing between the tooling-holes, and quantities of the tooling-holes. The laser multi-layout data include quantities of the workpieces, spacing between the workpieces, surplus spaces after cutting all the workpieces, and cutting paths. In the exemplary embodiment, the laser parameters are the same as the punching parameters, that is, the quantities of the workpieces, the spacing between the workpieces, and the surplus spaces of the punching parameters and the laser parameters are the same. With the punching sub-system 100 and the laser sub-system 300 sharing the same parameters, machining precision between the punching process and the laser process is ensured.

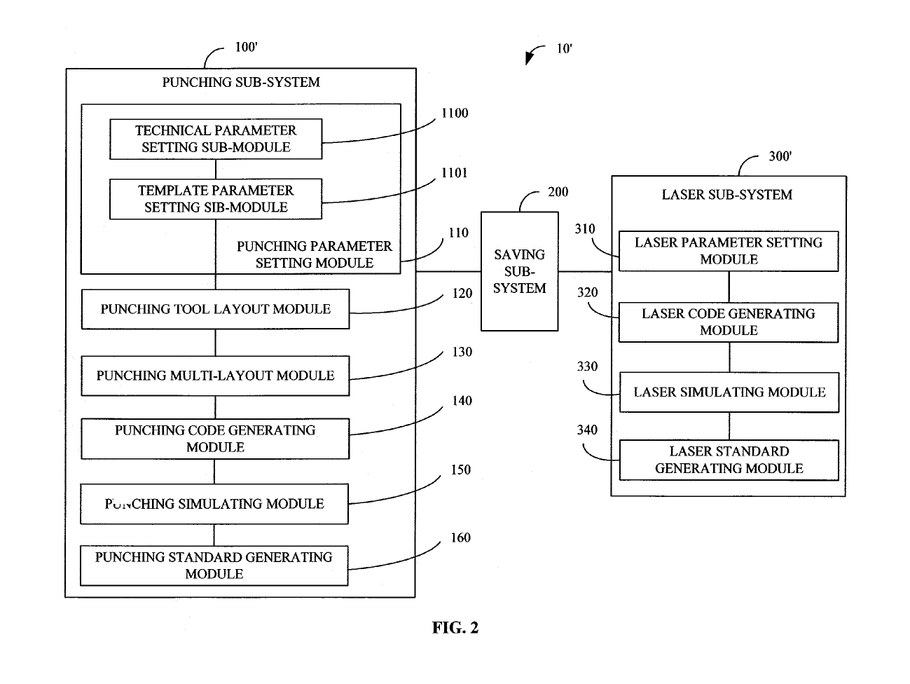

FIG. 2 is a block diagram of a sheet metal processing system 110′ of another exemplary embodiment of the present invention. The sheet metal processing system 10′ includes a punching sub-system 100′, the saving sub-system 200 from the first embodiment, and a laser sub-system 300′.

The punching sub-system 100′ further includes a punching simulating module 150 and a punching standard generating module 160, besides the punching parameter setting module 110, the punching tool layout module 120, the punching multi-layout module 130, and the punching code generating module 140. Therefore, descriptions of the punching parameter setting module 110, the punching tool layout module 120, the punching multi-layout module 130, and the punching code generating module 140 are omitted.

The punching simulating module 150 is used for simulating the punching process according to the punching codes. Operators can judge whether the punching process is correct or not during a simulation. If there is something wrong in the simulated punching process, the operators can modify the steps of the process in the corresponding modules, and simulate the punching process again.

The punching standard generating module 160 is used for automatically generating a punching standard to guide the operators punching the workpieces. In the exemplary embodiment, the punching standard generating module 160 is also used for storing machining time and utilization ratio obtained from the simulated punching process into a production management system.

The laser sub-system 300′ further includes a laser simulating module 330 and a laser standard generating module 340, besides the laser parameter setting module 310 and the laser code generating module 320. Therefore, descriptions of the laser parameter setting module 310 and the laser code generating module 320 are omitted.

The laser simulating module 330 is used for simulating the laser process according to the laser codes. Operators can judge whether the laser process is correct or not during a simulation. If there something wrong in the simulated laser process, the operators can modify the steps of the process in the corresponding modules, and simulate the laser process again.

The laser standard generating module 340 is used for automatically generating a laser standard to guide the operators cutting the workpieces. In the exemplary embodiment, the laser standard generating module 340 is also used for storing machining time and utilization ratio obtained from the simulated laser process into a production management system.

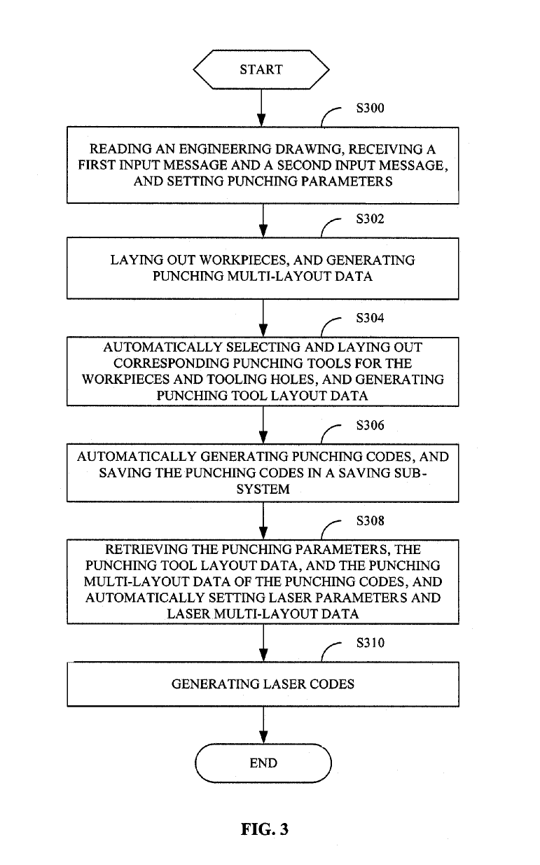

FIG. 3 is a flowchart of a sheet metal processing method of an exemplary embodiment of the present invention. In step S300, the punching parameter setting module 110 reads the engineering drawing, receives the first input message and the second input message, and sets the punching parameters according to the first input message and the second input message. In step S302, the punching multi-layout module 130 lays out the workpieces according to the punching parameters, and automatically generates the punching multi-layout data. In step S304, the punching tool layout module 120 selects and lays out the corresponding punching tools according to the punching parameters for the workpieces and the tooling-holes, and automatically generates the punching tool layout data. In step S306, the punching code generating module 140 automatically generates the punching codes according to the punching parameters, the punching tool layout data, and the punching multi-layout data, and automatically saves the punching codes in the saving sub-system 200.

In step S308, the laser parameter setting module 310 retrieves the punching parameters, the punching tool layout data, and the punching multi-layout data of the punching codes from the saving sub-system 200, and automatically sets the laser parameters and the laser multi-layout data according to the punching parameters, the punching tool layout data, and the punching multi-layout data. In step S310, the laser code generating module 320 automatically generates the laser codes according to the laser parameters and the laser multi-layout data. Accordingly, in the above mentioned method of the exemplary embodiment, the punching parameters, the punching tool layout data, and the punching multi-layout data of the punching codes are reused by the laser parameter setting module 310 because they already include characteristics of the original first and second input messages from the engineering drawing. Therefore, high processing efficiency of the method can be easily achieved.

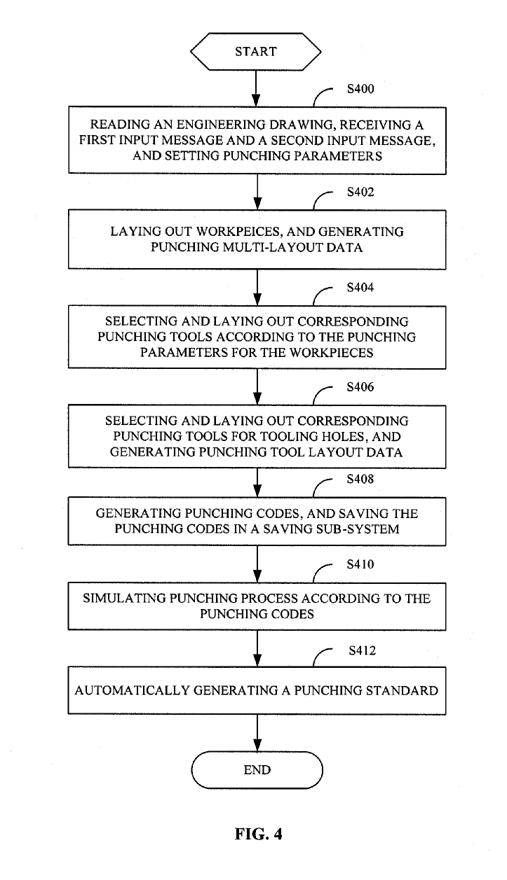

FIG. 4 is a flowchart of a punching method of the sheet metal processing method of an exemplary embodiment of the present invention. In step S400, the punching parameter setting module 110 reads the engineering drawing, receives the first input message and the second input message, and sets the punching parameters according to the first input message and the second input message. Firstly, the technical parameter setting sub-module 1100 reads the engineering drawing, receives the first input message, and automatically sets the technical parameters according to the first input message. Secondly, the template parameter setting sub-module 1101 receives the second input message, and automatically sets the template parameters according to the second input message.

In step S402, the punching multi-layout module 130 lays out the workpieces according to the punching parameters, and automatically generates the punching multi-layout data. In step S404, the punching tool layout module 120 selects and lays out the corresponding punching tools according to the punching parameters for the workpieces. In another exemplary embodiment, the step S404 can occur before the step S402. In step S406, the punching tool layout module 120 selects and lays out the corresponding punching tools for the tooling-holes, and generates the punching tool layout data.

In step S408, the punching code generating module 140 automatically generates the punching codes according to the punching parameters, the punching tool layout data, and the punching multi-layout data, and automatically saves the punching codes in the saving sub-system 200. In step S410, the punching simulating module 150 simulates the punching process according to the punching codes. In step S412, the punching standard generating module 160 automatically generates the punching standard.

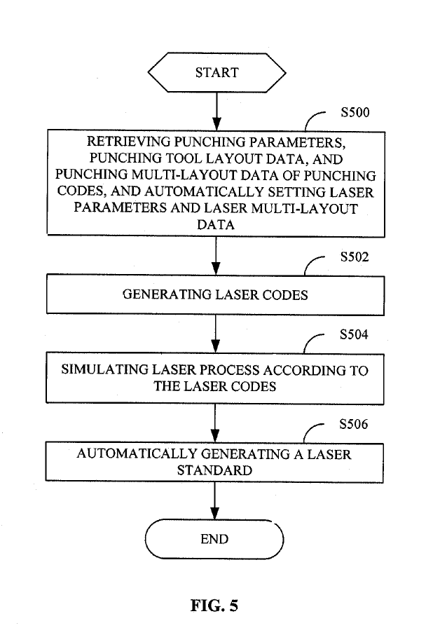

FIG. 5 is a flowchart of a laser cutting method of the sheet metal processing method of an exemplary embodiment of the present invention. In step S500, the laser parameter setting module 310 retrieves the punching parameters, the punching tool layout data, and the punching multi-layout data of the punching codes from the saving sub-system 200, and automatically sets the laser parameters and the laser multi-layout data accordingly. In step S502, the laser code generating module 320 automatically generates the laser codes according to the laser parameters and the laser multi-layout data. In step S504, the laser simulating module 330 simulates the laser process according to the laser codes. In step S506, the laser standard generating module 340 automatically generates the laser standard.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A sheet metal processing system comprising:
a punching sub-system for generating punching codes, the punching sub-system comprising:
a punching parameter setting module for reading an engineering drawing, receiving a first input message and a second input message, and setting punching parameters;
a punching multi-layout module for laying out a plurality of workpieces according to the punching parameters, and generating punching multi-layout data;
a punching tool layout module for selecting and laying out corresponding punching tools according to the punching parameters for the workpieces and tooling-holes, and generating punching tool layout data; and
a punching code generating module for generating the punching codes according to the punching parameters, the punching tool layout data, and the punching multi-layout data;
a saving sub-system for saving the punching codes generated by the punching sub-system; and
a laser sub-system for retrieving the punching parameters, the punching tool layout data, and the punching multi-layout data of the punching codes from the saving sub-system, setting laser parameters and laser multi-layout data, and generating laser codes according to the laser parameters and the laser multi-layout data.

2. The sheet metal processing system of claim 1, wherein the punching parameters comprise a technical parameter and a template parameter.

3. The sheet metal processing system of claim 2, wherein the punching parameter setting module comprises:
a technical parameter setting sub-module for reading the engineering drawing, receiving the first input message, and automatically setting the technical parameter according to the first input message; and
a template parameter setting sub-module for receiving the second input message, and automatically setting the template parameter according to the second input message.

4. The sheet metal processing system of claim 2, wherein the first input message comprises machining materials and machining modes of the sheet metal, and the second input message comprises template types of the sheet metal processing.

5. The sheet metal processing system of claim 4, wherein the technical parameter comprises length, width, thickness, and machining characteristic of the sheet metal, and the template parameter comprises template types, template sizes, locations of template tooling-holes, spacing between the tooling-holes, and quantities of the tooling-holes.

6. The sheet metal processing system of claim 5, wherein the punching tool layout data comprise the punching tools for the workpieces and the tooling-holes, and machining sequences for the punching tools.

7. The sheet metal processing system of claim 6, wherein the punching multi-layout data comprise quantities of the workpieces, spacing between the workpieces, and surplus spaces after punching all the workpieces.

8. The sheet metal processing system of claim 7, wherein the laser parameters comprise length, width, thickness, machining characteristic of the sheet metal, template types, template sizes, locations of template tooling-holes, spacing between the tooling-holes, and quantities of the tooling-holes.

9. The sheet metal processing system of claim 8, wherein the laser multi-layout data comprise quantities of the workpieces, spacing between the workpieces, surplus spaces after cutting all the workpieces, and cutting paths.

10. The sheet metal processing system of claim 1, wherein the punching sub-system further comprises:
a punching simulating module for simulating the punching process according to the punching codes; and
a punching standard generating module for automatically generating a punching standard.

11. The sheet metal processing system of claim 1, wherein the laser sub-system comprises:
a laser parameter setting module for retrieving the punching parameters, the punching tool layout data, and the punching multi-layout data of the punching codes from the saving sub-system, and setting the laser parameters and the laser multi-layout data; and
a laser code generating module for generating the laser codes according to the laser parameters and the laser multi-layout data.

12. The sheet metal processing system of claim 11, wherein the laser sub-system further comprises:
a laser simulating module for simulating the laser process according to the laser codes; and
a laser standard generating module for automatically generating a laser standard.

13. A sheet metal processing method comprising:
reading an engineering drawing, and setting punching parameters;
laying out workpieces, and generating punching multi-layout data;
selecting and laying out corresponding punching tools for the workpieces and tooling-holes, and generating punching tool layout data;
generating punching codes according to the punching parameters, the punching tool layout data, and the punching multi-layout data, and saving the punching codes in a saving sub-system;
retrieving the punching parameters, the punching tool layout data, and the punching multi-layout data of the punching codes from the saving sub-system, and automatically setting laser parameters and laser multi-layout data; and
generating laser codes according to the laser parameters and the laser multi-layout data.

14. The sheet metal processing method of claim 13, wherein the punching parameters comprise a technical parameter and a template parameter.

15. The sheet metal processing method of claim 14, wherein the step of reading an engineering drawing, and setting punching parameters comprises:
reading the engineering drawing, receiving a first input message, and setting the technical parameter; and
receiving a second input message, and setting the template parameter.

16. The sheet metal processing method of claim 13, further comprising simulating the punching process according to the punching codes.

17. The sheet metal processing method of claim 13, further comprising automatically generating a punching standard.

18. The sheet metal processing method of claim 13, further comprising simulating the laser process according to the laser codes.

19. The sheet metal processing method of claim 13, further comprising automatically generating a laser standard.

20. A method for processing a sheet metal, comprising the steps of:
retrieving input messages from an engineering drawing;
generating parameters and data of a first kind usable to apply in a first machining process according to said input messages;
generating first machining codes to execute said first machining process according to said parameters and data of said first kind;
retrieving said parameters and data of said first kind and said first machining codes;
generating parameters and data of a second kind usable to apply in a second machining process according to said parameters and data of said first kind and said first machining codes; and
generating second machining codes to execute said second machining process according to said parameters and data of said second kind.
